(19) United States
(12) Patent Application Publication
(10) Pub. No.: US 2022/0175497 A1
(43) Pub. Date: Jun. 9, 2022

(54) BIONIC IMPLANTS

(71) Applicant: AF PRAKTYKA STOMATOLOGICZNAFRYDRYCHEWICZ, Warszawa (PL)

(72) Inventor: Artur FRYDRYCHEWICZ, Warsaw (PL)

(21) Appl. No.: 17/551,659

(22) Filed: Dec. 15, 2021

Related U.S. Application Data
(63) Continuation-in-part of application No. 16/097,246, filed on Oct. 27, 2018, now abandoned.

(30) Foreign Application Priority Data
Apr. 28, 2016 (PL) P.417028

(51) Int. Cl. A61C 8/00

(52) U.S. Cl. CPC A61C 8/0043; A61C 8/0036

(57) ABSTRACT

The present invention relates to a customized or standardized bionic implant and its manufacturing, especially for dental applications. According to the first variant of the invention, the implant is characterized in that its single-component anchor possesses at least two bionic arms (2) tapering circumferentially, thereby creating at least one pointed (5) and/or linear (6) blade on each arm (2). According to the second variant of the implant, the single-component anchor possesses at least two bulging arms (2) forming at least one protrusion (4) on each of them. The manufacturing method depends on whether the implant is standardized, new and customized or is a modification of an implant selected from a digital library of standardized implants. Physical form of embodiments of the anchor may be printed in a 3D printer. In the case of customized implants, the process commonly comprise obtaining tomographic images of the biological target. In the case of designing a new implant, a panoramic curve/curves and panoramic surface are set and become the basis for the arms (2) of the implant's virtual anchor.

### FIELD OF THE INVENTION

The present invention relates generally to bionic implants and their manufacturing, and more particularly to bionic implants for dental applications. Implants consist of a core (corpus) and an anchor. The core is equipped with a prosthetic platform, which allows for the attachment of prosthetic or secondary components.

### BACKGROUND OF THE INVENTION

Traditional endosseous implants include the following: cylindrical and conical screw-type implants; threadless cylindrical implants; disc implants, needle implants and blade implants. The names assigned to these different groups of implants are derived from the shape of the anchor, i.e., the part of the implant that attaches to the bone. Their common feature is a simple geometric form usually designed to ensure ease of manufacture using traditional material processing methods (milling, threading, sheet metal cutting). Implants can be single-component or multiple-component devices. The material traditionally used to manufacture implants is titanium, while the newest implants are made from zirconia or synthetic materials, e.g. PEKK—polyetherketoneketone. Most of these implants are inserted in the alveolar process by way of screwing the implant anchor into the bone.

The most popular implant anchors currently take the form of a cylindrical or conical screw. The latter tapers towards the bone facilitating the screwing in of the implant, e.g. KR200416306(Y1). To impede implant rotation around the longitudinal axis, various notches, indentations, and intersecting holes are used, as is for example shown in patent specifications CN101297772 (A), CN1565390(A).

The newest types of implants are bionic and biomimetic. For the needs of this description, bionic implants are defined as implants designed with inspiration from functions of objects present in nature. By way of contrast, biomimetic implants mimic the structures they replace. The best-known biomimetic implants imitate the shape of a tooth's roots (e.g. Replicate or Bioimplant). Most frequently, an anchor of this type differs from a pure replica of a tooth root in that its external surface possesses indentations or protrusions—these serve to increase the anchor's surface area, facilitate its embedding in the bone and create space for bone growth. Implants like these are only used in immediate implant placement procedures, and they are designed exclusively for making cemented restorations. Prior to the procedure, a structure approximate to that of the tooth root it is intended to replace is created based on analysis of tomographic imaging. Such anchors are manufactured by means of milling or CAD/CAM (Computer Aided Design/Computer Aided Manufacture) or SLM (Selective Laser Melting) methods.

The idea of bionic implants is to create a broad base for the implant so as to ensure greater stability and allow for many buttress points. With this aim in mind, attempts have been made to use needle implants whose anchors consist of separate needles, which, after being independently inserted into the bone, are then attached to the core by means of gluing or welding.

There are solutions where the implant resembles a tooth root but also possesses a regular geometrical shape, such as the implant shown in utility model CN203468769 (U). The anchor of this implant is shaped like a cylinder, which branches out into two arms with a uniform cross-section along their entire length.

A slightly different example of a bionic implant is that of the multi-root implant described in patent specification US2009061387 (A1). Emerging from the core are 2-4 separate, regularly shaped roots that taper towards the apex but have blunt ends. The number of the implant anchor's roots corresponds to the number of roots of the tooth that the implant is replacing. Subperiosteal implants (placed on top of the bone) that recreate the bone surface can also be called bionic implants. They were once made from a bone model prepared after taking impressions (a highly burdensome procedure) and using the lost-wax technique. They are currently made by use of tomographic imaging (3D) models, using CAD/CAM or SML methods.

A partially subperiosteal implant is shown in patent specification KR101469648 (B1). Here the implant has a titanium coating in the form of a mesh with openings for screws. The titanium mesh is placed on osseous tissue, thereby reproducing its shape, and soft tissue is placed on top of the titanium mesh. The screws are screwed into the bone in order to ensure attachment of the titanium mesh, which also includes rings of a prosthetic platform.

If it is necessary to recreate the root system of a multi-rooted tooth whose roots branch outwards creating a wider base deep in the bone tissue, solutions involve the construction of anchors consisting of at least two parts that are attached during implant placement in order to avoid excessive drilling in the post-extraction socket.

In accordance with CN 100571651 C (WO2008125049 (A1)), holes are drilled in an anchor whose main part is screw-shaped, and during implant placement arms are placed in these holes at an acute angle to the axis of the main part of the anchor. The arms possess a regular cylindrical shape finished with a screw section. An implant anchor composed of two regularly shaped parts whose position corresponds to the branches of the tooth's roots is also shown in utility model CN201404302 (Y). A similar idea inspired the construction of the bionic implants described in patent applications US20130288201 (A1), U.S. Pat. No. 5,984,681 (A) and CN101249023 (A). A major drawback of the solution in which the anchor consists of two or more parts and is attached as a whole in situ, is that there is a risk of the formation of micro-gaps, through which bacteria can make their way to the bone, thereby causing inflammation around the implants (peri-implantitis).

Numerous modern radiographic techniques have contributed to advances in implantology, especially computed tomography, CT (currently the most recommended approach is cone beam computed tomography—CBCT, due to its reduced radiation dose). In radiology, analysis of tomographic imaging utilises layers. It is possible to obtain an image of a layer of any section of the body, e.g. the head. In dentistry, CT scans are taken of the maxilla and the mandible. At present, the minimal layer thickness (slice) that can be achieved with advanced tomographic imaging device is 70 μm—the same as the voxel size used in such devices. The maximum thickness of a layer is the full scanning range (the summation layer). Traditional radiology distinguishes between three basic planes: frontal, sagittal and axial. These correspond to the position of the main tomographic layers—orthogonal (straight) layers—while the software currently used for analytical purposes also allows for layers that diverge from traditional planes by the angle desired by the user, producing oblique layers. It is also possible to produce a slice image comprised of consecutive short fragments of oblique layers at a tangent to the so-called panoramic curve. Panoramic curves are drawn arbitrarily with regard to objects of interest. This makes it possible to obtain a planar image of any given cross-section, known as the panoramic layer. The panoramic layer is used to create an image derived from computed tomography (CT), which is similar to a traditional pantomogram, also known as a panoramic image. Basing on the panoramic layer, cross-sections perpendicular to the panoramic layer are also obtained. This makes it possible to assess the availability of tissue essential for proper implant placement prior to performing the procedure, and ensures better preparation for planned procedures by allowing for the virtual superimposition of currently used implant models onto the image, i.a. This aids the selection of the right size of the implant.

Another modern implantological method is guided implant placement, which is currently employed by many manufacturers. This approach involves using tomographic imaging and 3D printing to create surgical templates. Its purpose is to achieve precise implant placement, which requires ensuring the implants position in the bone is set precisely with regard to both the surrounding tissue as well as future prosthetic restorations, using tomography analysis software. In order for implant placement to proceed according to plan, a 3D printed template should be prepared detailing how surgical instruments (for example, drills) and the implant/implants should be inserted.

The use of traditional implants is associated with many problems.

The biggest problem in implantology is that of bone deficit, for if a suitable margin of bone tissue is not preserved, primary stability cannot be achieved. The matter is further complicated by sensitive anatomical structures, such as nerves, passing through the bone. In the case of the mandible, the current state of the art offers two ways of solving this problem. The first method is bone augmentation, which involves “building” bone above the nerve canal. This is a complicated procedure that carries a risk of complications and a significant increase in costs due to the need for additional tools and materials. The second method is nerve lateralisation, which entails surgically cutting through the bone

and repositioning the nerve. Once again, however, this is a risky procedure, which can lead to nerve damage, on top of which the scope of the procedure itself is very extensive. Both methods prolong the course of treatment due to the additional rehabilitation time required. In the case of the maxilla, implant placement requires augmentation procedures (a sinus lift, a bone graft from the iliac crest or other techniques of alveolar ridge reconstruction), which in turn have undesirable consequences. This often leads to situations where the patient is reluctant to undergo treatment. One compromise approach is to use threaded implants of small dimensions, which results in large unit loads on the contact surface between the implant and the bone. Bone remodelling as a result of increased loads leads to osseodensification and a decline in volume, which causes implants designed as endosseous implants to function as partially subperiosteal implants that remain only partially embedded in the bone. This is particularly disadvantageous in cases where the geometry of the implant creates sharp edges (for example, thread), which because they are not immersed in the bone cause harm to soft tissue, thereby damaging it and often causing inflammation, i.e. peri-implantitis.

### SUMMARY OF THE INVENTION

Various aspects of the present invention introduce a new approach to the construction and functioning of bionic implants.

In accordance with an aspect of an aspect of the present invention, a bionic intraosseous implant comprising:

at least one rounded core having a prosthetic platform;

at least one anchor integrated with the core;

the single-component anchor comprising at least two bionic arms being curved and tapering towards its distal end and each having at least one bone cutting edge for bone penetration by the arm, said cutting edge extending at least partially along the arms longitudinal curvature, the longitudinal axis of any of the implant anchor arm running from the point on the core axis wherein the shape of each anchor and all its arms depend on the properties of the bone to which the anchor is dedicated. The feature that the axis of each arm originates from a point on the axis of the core—this is due to the way the implant is designed.

The implant is very often a dental implant.

In some preferable embodiments at least one of those arms with cutting edge further comprises at least one pointed end.

In preferable embodiments the implant is customized to a specific patient. In an embodiment for the cases of bone deficit where the bone cannot be prepared too deeply the anchor has at least three accordingly short arms with cutting edges.

In an embodiment at least two of any arms of the at least one anchor are interfused to form an integrated volume. In a different embodiment at least one arm without cutting edges comprises a pointed end which constitutes a central spike. In another embodiment at least one of at least two of any arms are branched to at least two arm branches.

In some preferable embodiments of the invention the axis of the implant core is a curved line.

In a preferable embodiment, a fragment of the arm includes a protrusion to lean on the bone and/or provide support for the surrounding tissues, both hard and soft. Preferably, the prosthetic platform of the core possesses a concavity, which serves as a dome that can be filled with curable material, wherein the cross-sectional area of the dome opening is smaller than the cross-sectional area of its midsection.

Bionic arms are, within the understanding of the present invention, arms modeled on biological forms inspired by shapes and forms found in nature, such as predator claws, animal tooth crowns (e.g. shark teeth), fingers, catches, plant spikes, roots, bulbs, thorns, etc. The bionic form is commonly understood in implantology as an imitation of the natural shape of a human tooth root, however it should be better called biomimetic. In contrast, in the present invention the meaning of the word “bionic” refers solely to the various biological forms mentioned above, intended to be stuck into, pierce into, sink into the tissue. Cutting edges are on the arm sections that are surgically inserted directly into the bone in a similar manner as a knife, chisel, nail, or cutter to initiate bone penetration, the rest of the arm acts as a wedge, spreader or spacer to displace the bone in micro-scale. The shapes of the biological forms of the arms combine their natural dynamic properties with technical cutting elements for the best performance. Anchor designed according to the above principles works also as a tool for bone densification and distraction during implant placement.

The observation that nature adjusts form to function regardless of the scale is utilised in certain aspects. Thus, when designing bionic implants in accordance with aspects of this invention, the aim was also to apply the rotational odd symmetry existing in the plant world in order to increase durability.

In accordance with aspects of the present invention, the implant anchor's arms possess a number of functions and associated advantages. These include increased anchor surface area; primary implant stability enhanced by the elimination of rotation; the establishment of an implant insertion trajectory by intruding into and binding in the bone; bracing against the bone; wedging that prevents deeper immersion, and buttressing the bone. The arms can either perform certain functions, or a single arm can perform several different functions, such as acting as a sharp end for intruding into the bone, or inhibiting further intrusion with a bulge on the proximal part of the implant.

In accordance with aspects of the present invention, the anchor allows for more gradual anchoring in the bone as well as a gradual transition over time from functioning as an endosseous implant to functioning as a partially subperiosteal implant. The arms are also used to model space for tissues around the implant. They also make it possible to adjust the geometry of the implant to the shape of any bone defect.

As was mentioned above, the arms of the implant anchor can provide space for bone reconstruction. The blades and spikes of the arms act as retention elements that ensure primary stability. They serve as an anti-rotational, supporting function and take on the main preliminary load during the healing stage.

Certain embodiments of the present invention are especially suited for one-stage implants as well as for implants that feature an internal prosthetic platform in their core.

Implants utilizing certain aspects of the invention perform well in cases of immediate implant placement as well as in delayed procedures, in extremely shallow and deep implant placement procedures, in both customised and standardised procedures. They open up new possibilities for developing surgical techniques. It is possible to piezosurgically prepare the implant bed using blades identical to the implant, to place implants by means of hammering (manual or aided with certain instruments, e.g. a magnetic mallet), and other methods. There is a trend regarding the placement of increasingly shorter implants. Certain embodiments of the present invention enables implant placement in difficult anatomical conditions without the need for bone augmentation. Aspects of this invention enable the axis of attachment of prosthetic restorations or secondary elements to be independent of the axis of implant placement.

Certain implants in accordance with the invention may be manufactured using traditional methods or with the latest CAD-CAM or CAD-SLM software by way of example. All that is needed to manufacture the some embodiments of the invention are zirconia, titanium, PEKK, and Ti alloys—materials that are widely used in implantology. Likewise, the surface can be finalised using well-known techniques.

Aspects of the invention allows for lower costs and advances the availability of personalised solutions in medicine.

Various aspects and embodiments of the invention offer additional benefits, such as, by way of non-limiting examplecircuventing the need for an expanded internal interface (connection); there are fewer faults; the elimination of areas of bacterial retention; and the possibility to achieve multidimensional stability (multi-point buttressing). This invention facilitates primary and secondary stability, and it reduces tension in the bone surrounding the implant, owing to a favourable distribution of forces.

### SHORT DESCRIPTION OF DRAWINGS

The summary above, and the following detailed description will be better understood in view of the enclosed drawings which depict details of certain preferred embodiments. It should however be noted that the invention is not limited to the precise arrangement shown in the drawings and that the drawings are provided merely as examples.

FIG. 1 shows the first embodiment of a standard implant;

FIG. 2 shows the second embodiment of a standard implant;

FIG. 3 shows the dmbodiment of a standard implant;

FIG. 4 shows the fourth embodiment of both a standard implant and an individual implant;

FIGS. 5a, 5b, 5c and 5d present different versions of a variation of a standard or individual implant;

FIG. 6a shows an example of an implant

FIGS. 6b, 6c, 6d and 6e show cross-sections of the anchor of FIG. 6a at different heights;

FIGS. 7a, 7b and 7c show a view of sample arms of an implant anchor;

FIG. 8 shows an implant that uses the arms from FIGS. 7a, 7b and 7c;

FIGS. 9a, 9b, 9c, 9d, 9e, 9f, 9g, 9h, 9i, 9j, 9k shows sample views of cross-sections of implant anchors;

FIGS. 10a, 10b, 10c, 10d, 10e, 10f and 10g shows examples of different individual arms of implant anchors;

FIGS. 11a, 11b, 11c, 11d, 11e, 11f, 11g, 11h, 11i, 11j, 11k, 11l, 11m, 11n, 11o, 11p, 11r, 11s, 11t and 11u show cross sections of sample arms;

FIGS. 12a, 12b, 12c, 12d, 13a, 13b, 13c and 13d show implants with different forms of anchors;

FIGS. 14a and 14b show cross-sectional examples of the alveolar process with a drawn implant outline;

FIG. 15a shows a cross-section of the alveolar process by the maxillary sinus with the implant;

FIGS. 15b, 15c, 15d, 15e, 15f and 15g show different embodiments of an implant anchor suitable for implant of FIG. 15a;

FIG. 16a show a view of a maxilla with examples of anchors drawn in;

FIG. 16b, 16c, 16d show the views of implants placed in the maxilla of FIG. 16a;

FIG. 17a show a view of a mandible with examples of anchors drawn in;

FIGS. 17b, 17c show the views of implants placed in the mandible of FIG. 17a;

FIG. 18a, shows a view from above of a fragment of the mandible with a drawn implant anchor, while FIG. 18b shows a fragment of the mandible with implant anchor in perspective view.

FIG. 19 shows the view from above of a fragment of the mandible with implant anchor in another embodiment.

FIG. 20, shows a perspective view of an embodiment of one implant with two cores.

### DETAILED DESCRIPTION

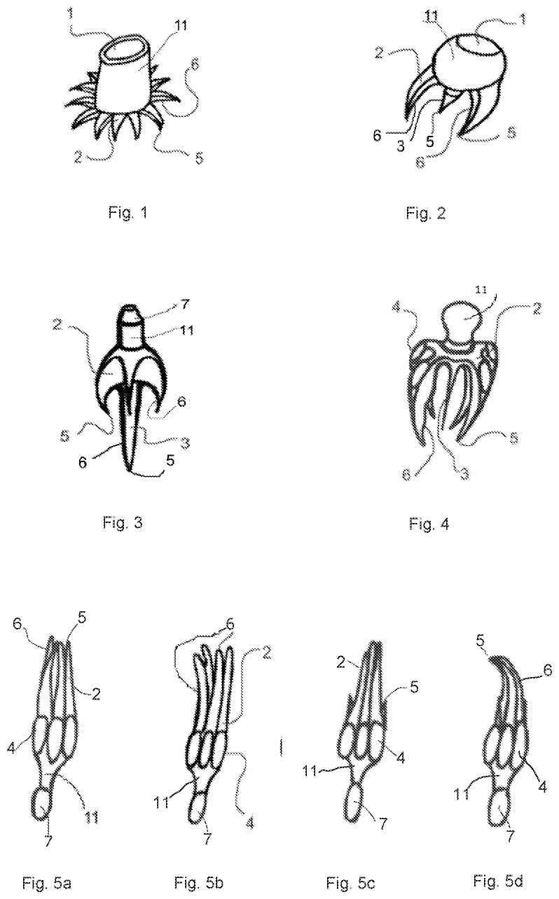

FIGS. 1-3 show examples of standard implants, which can be calibrated to create a range of implants ready for placement. In FIG. 1 the anchor is constructed out of a row of arms 2 in the shape of short claws finished with point end 5 as well as cutting edges 6. This kind of implant can be anchored at a very shallow depth, e.g., at 2 mm. Even this slight embedding of many short arms in the bone suffices, on account of the largest possible anchor surface achieved in such conditions and the relatively large area of the implant base, thus ensuring a high level of primary stability. In FIG. 1 as well as FIG. 2 the core 11 of the implant possesses a dome-like concavity 1. This makes it possible to place different materials, such as elastomer and ferromagnetic materials, inside the implant. FIG. 2 shows an implant with a standard structure and a greatly simplified geometry. It has a spherical core 11 possessing a dome 1 and a central spike 3 as well as three sharp arms 2, which will pierce the bone like a thumbtack. In the case of this embodiment, implant placement ensures maximum simplicity. It is also suitable for temporary implant placement procedures, as the removal of such an implant would be simple, especially if fewer arms were used and the arms' surface is smooth.

The implants presented in FIGS. 1 and 2 are suitable for cases where the bone cannot be prepared too deeply, e.g. only at 2 mm. In the current state of the art, the problem has been to achieve stability, especially primary stability. Screw-type implants are not very well suited to cases where the insertion depth is less than 4 mm. In the current state of the art, screws with a large thread (disc) diameter are used, although they have a significantly smaller surface than that achieved by the anchor in accordance with the invention. In the same conditions, if we used the implant with the arms specified in the present invention we could achieve a much greater surface for the implant in the bone, which results in high primary and secondary stability parameters.

The anchor of the implant from FIG. 3 possesses side arms 2 in the form of claws and a much longer spike 3 which makes it possible to set the original axis of placement. The arms 2 are tapered to form an arch. It is not necessary for all the side arms 2 to be embedded in the bone. A large amount of space is left around the implant anchor with this aim in mind so that the bone can grow into the space between the arms of the anchor, and at the edges of the side arms 2 we achieve support against the bone. During the healing stage the bone will also be able to grow above the anchor.

FIG. 4 shows the anchor of the implant intended for the alveolus following extraction of a lower molar. An implant of this kind is designed for immediate implant placement procedures. Located between the roots of the molar is the interradicular septum. The implant anchor has a central spike 3, which after extraction of the tooth sinks into the interradicular septum. The central spike 3 does not damage the septum in the same way as a screw-type implant (in the current state of the art), which requires drilling a hole with a much greater diameter than the diameter of the hole formed after inserting the central spike 3. Penetration of the interradicular septum ensures primary stability and determines the trajectory of the implant placement axis. The other arms 2 that enter the alveolus are significantly more branched than the original natural tooth or any kind of traditional implant used in such cases. These branched arms 2 increase the surface of bone apposition and the internal volume of the body of the implant into which the bone grows. The arms 2 also possess cutting edges 6 directed towards the interior of the implant body. These cutting edges also add primary stability by encroaching from the outside into the interradicular septum stretched by the central spike 3. The sharpened tips of the arms 2—pointed ends 5—are anchored at the base of the alveolus. In the lower core 11 section the arms possess protrusions 4. These ensure that not too much pressure is placed on the bone in the zone where the bone is thinnest and the target loads are greatest. The complexity of the anchor surface in accordance with the specifications of the invention enables greater integration of the implant anchor with the bone than is the case with a traditional implant based on the current state of the art.

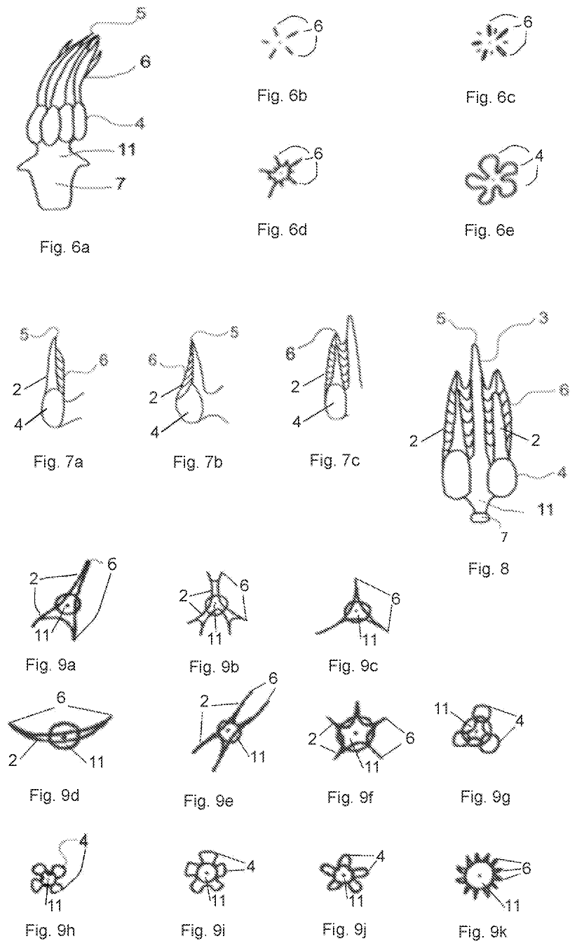

FIGS. 5a, 5b, 5c, 5d, 6a, 6b, 6c, 6d, 6e and 8 show other examples of implant anchors that can be used in immediate implant placement. The anchor of the configured implant is to a certain extent modelled on the patient's own teeth, but differs from the original teeth in that it possesses arms 2, which form pointed ends 5 and cutting edges 6 at the root apex, and protrusions 4 in the cervical section. Each of the side arms 2 can branch out into, e.g. two more arms whose cutting edges can adjust the trajectory of implant placement. Moreover, if the anchor also has side arms 2 with cutting edges 6 at the edges, as in FIGS. 8 and 9, it can cut into the walls of the alveolus with these cutting edges 6, thereby creating additional stability. On the other hand, in the region where healing conditions should be as stable as possible there are no cutting edges, only smooth surfaces—protrusions 4, thereby resulting in reduced alveolar filling. During the course of remodelling, the bone tissue grows into the space between the arms 2 in the area of the largest secondary loads. In addition, in this area, the arms 2 remain immediately after implantation in gentle contact over a larger surface with bone tissue at the tops of the protrusions 4 spreading the alveolus below the bone itself, allowing tissue healing without compression while preserving their original outline. The elasticity of the bone ensures an even distribution of pressure along the circumference of the alveolus.

FIGS. 7a, 7b and 7c shows examples of arms, which can be used in anchors of the type presented in FIGS. 5a, 5b, 5c, 5d, 6a, 6b, 6c, 6d, 6e and 8. Visible protrusions 4 pass through the thickened section of the arm, thereby ensuring rigidity of the structure, while further on is part of the arm, which features cutting edge(s) 6. Protrusions 4 are responsible for taking the greatest secondary loads—here secondary stability will result from bone apposition. Cutting edge 6 in the examples presented in FIGS. 7a, 7b and 7c is located either inside the body of the implant (towards the interradicular septum of the alveolus—example 7a), or directed outside the body of the implant towards the alveolus—example 7b) or one arm features two cutting edges pointed in opposite directions, connected with a cutting edge running through the apex of the arm (example 7c). For example, 8c shows a situation where the greater part of the cutting edge pointed towards the interior of the implant body connects with the core of the implant.

FIG. 8 shows an implant capable of replacing, for example, a two-rooted tooth or a single-rooted tooth with an elliptical cross-section of the root. The implant anchor possesses the arms from FIG. 7c. In this example, it is equipped with a central spike 3 situated on the axis of the implant core 11. Its role is to stabilise the implant path of insertion, giving the latter path a direction. In the example from FIG. 8 the arms interpenetrate, forming in this way a common area—we can see the exterior contour.

FIGS. 9a, 9b, 9c, 9d, 9e, 9f, 9g, 9h, 9i, 9j, 9k presents views of cross-sections of implant anchors; these are cross-sections in relation to the axis of the implant core 11. The anchors of the implants are multi-armed. The cross-sections are at different heights and the side cutting edges 6 are visible, as are protrusions 4.

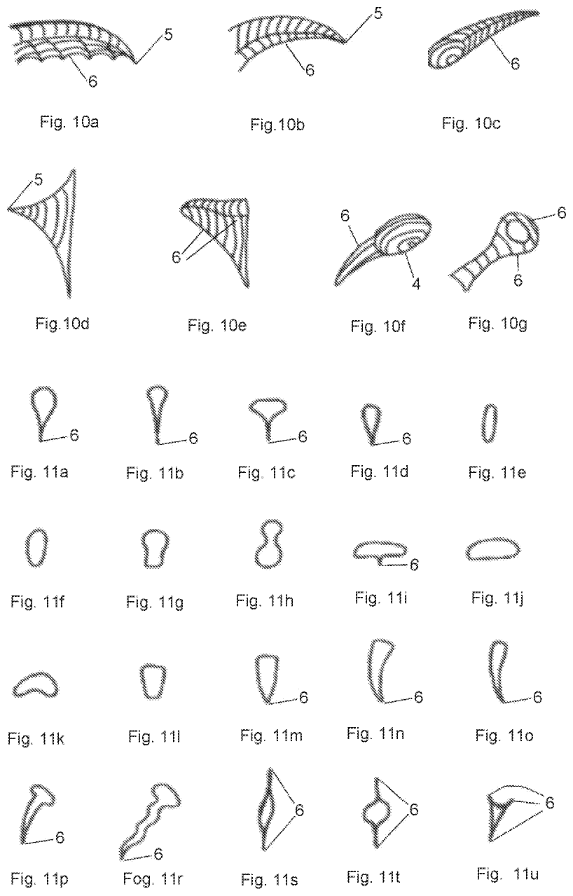

FIGS. 10a, 10b, 10c, 10d, 10e, 10f and 10g present examples of different individual arms with a variety of complex shapes. The arm profile can be convex, concave or convex-concave.

The arms of the implant anchors in accordance with the present invention vary greatly, just as the needs are different on account of differences in the structure of maxillary and mandibular bones. The arms of implants ensure optimal use of bone volume by maintaining low unit pressure as well as integration with the bone tissue, thereby allowing for its stimulation with even loads. When the implant is inserted some cutting edges 6 perform the role of fins the moment they come into contact with the bone—the movement of the whole implant will additionally be controlled and directed in accordance with the direction of these cutting edges. These cutting edges 6 can thus be used to control and correct the performance of the implant while it is being placed in the bone. The finite element method applied to these arms and to the anchor or implant as a whole ensure optimal configuration of the geometry of the arms and anchor from the viewpoint of structural analysis and bone tissue penetration dynamics.

FIGS. 11a, 11b, 11c, 11d, 11e, 11f, 11g, 11h, 11i, 11j, 11k, 11l, 11m, 11n, 11o, 11p, 11r, 11s, 11t and 11u show examples of cross-sectional shapes of particular arms, where some of these cross-sections may be cross-sections of the same arm at different heights. In other words, at one end an arm is sharp on one side and rounded on the other, and above it the cutting edge becomes increasingly blunt until the end is rounded on both sides. The arms can assume many different shapes.

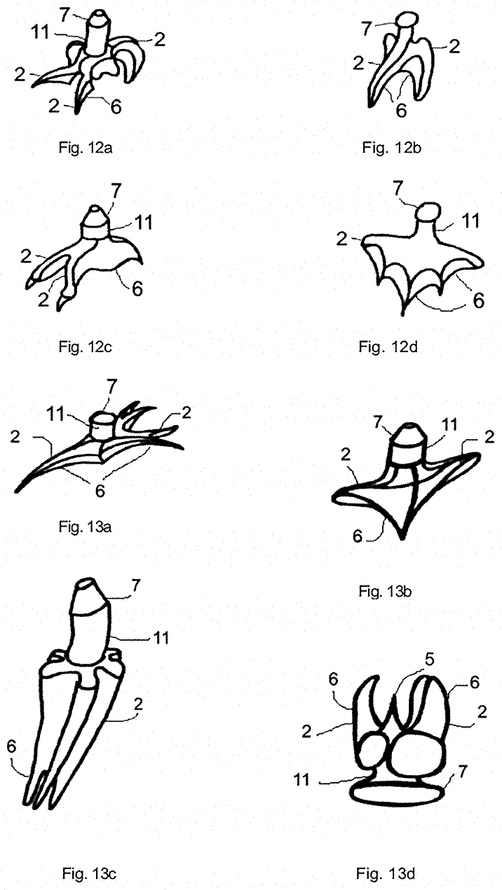

FIGS. 12a, 12b, 12c, 12d, 13a, 13b, 13c and 13d show many different forms of implant anchors in accordance with the present invention. The different shapes of anchors are suitable for different cases of implant treatment, depending on the shape of the alveolar processes and accessible depth of implant penetration. FIG. 13a shows the anchor of an implant suitable for shallow embedding, FIG. 13b shows an implant anchor suitable for cases involving a narrow alveolar process. Both examples are used with the osteodistraction technique (arms placed in the distraction gap). FIG. 13c shows an implant designed for immediate application as a replacement for a single-rooted tooth. FIG. 13d shows an implant intended for immediate application as a replacement for an upper molar.

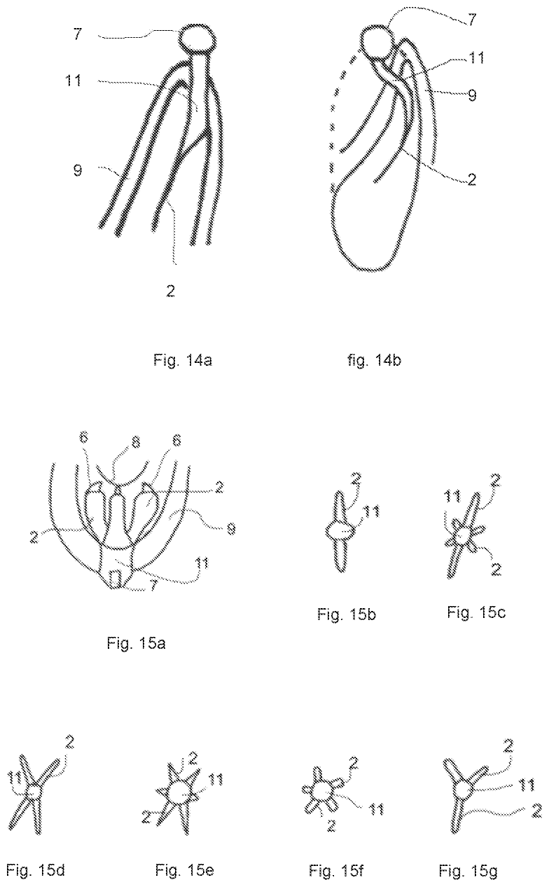

The examples shown in FIGS. 14a and 14b are cross-sections of bone tissue with an implant in place that is similar to the implant shown in FIG. 13b and they illustrate the possibility of optimally placing an anchor in the margin of a narrow alveolar process as well as the flexible position of the prosthetic platform with respect to the alveolar crest, depending on the shape of the implant core 11. The dotted line in FIG. 14a illustrates the original contour of the bone tissue. The prosthetic platform is placed in the optimal position for prosthetic reconstruction. Utilising the features of the present invention, the position of the prosthetic platform can be flexibly adjusted to the needs of the prosthetic restoration, while the anchor is maintained in the optimal position relative to the surrounding bone tissue. Prosthetic platform 7 is marked with a circle symbol. It allows for the most favourable distribution of forces in the bone—implant—prosthetic restoration complex. In accordance with the present invention, the anchor arms can be shaped in such a way as to maintain at all times an even margin of bone tissue around the anchor or an equal distance from the surface of the bone. The biggest loads are located close to the anchor's exit from the bone in the immediate vicinity of the points of force application. The anchors of the implant have cutting edges directed in such a way that they denote the trajectory of bone penetration. If a cutting edge is bent, the arm is inserted along the curvature of the cutting edge. The implant bed can be prepared for the placement of the anchor with an instrument identical in shape to the anchor and possessing cutting edges equipped with additional teeth—this instrument would be attached to a piezoelectric or sonic oscillation device used to prepare bone tissue. The implant bed will run through the external compact cortical layer of the bone, while further preparation will take place during implant placement, i.e. the anchor itself will be driven into the deeper layer of cortical bone with its cutting edges, thereby making it possible to control the propagation of the distraction gap through gradual expansion. It is important that the forces ultimately acting on the bone through the implant be transferred via a smooth surface so that even if overloading and resulting bone loss occurs, no sharp edges create traumatic nodes either for the bone or the soft tissue covering it, as happens in the case of threaded implants.

FIG. 15a shows a cross-section of the alveolar process with a placed implant, where the base of the maxillary sinus 8 and soft tissue 9 are also marked. This example is applicable when there is little space in the maxilla deep in the alveolar process on account of the danger of penetration into the maxillary sinus 8. Also shown are examples of cross-sections of anchors with arms 2 intended for application in such cases. They make it possible to utilise the volume of bone in each direction through various configurations of the arms, which can be inserted into the bone by increasing the implant anchor surface. One distinctive feature is that the implant core 11 itself remains at a distance from the sinus base, which is not possible with traditional screw-type implants and requires either additional procedures or runs a risk of the implant penetrating the sinus. Even if such screw-type implants do not break through during placement, but are set at a shallow depth under the base of the sinus, they cannot be subjected to significant loading before osseointegration.

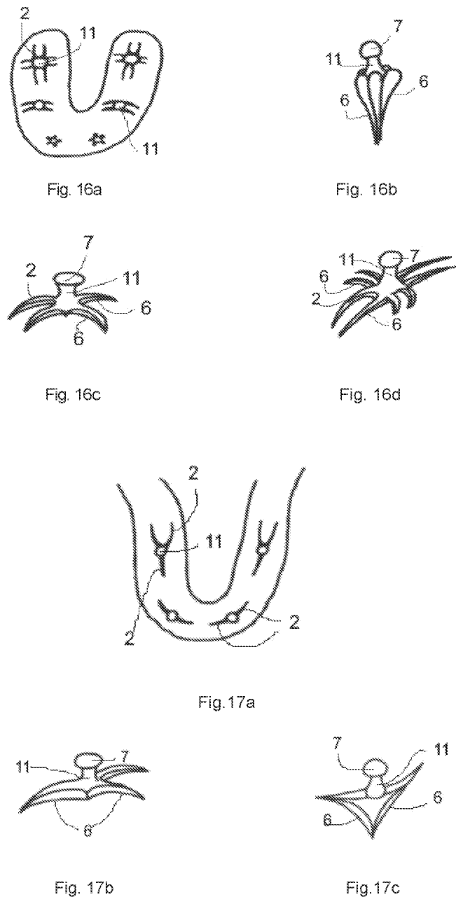

FIG. 16a shows an example of the distribution of different forms of implants in an edentulous maxilla while FIG. 16b, 16c, 16d examples of possible forms that such implants can take. Similarly, FIG. 17a presents an example of the distribution of different forms of implants in an edentulous mandible while FIGS. 17b, 17c a view of such implants. The use of these forms together with their location allows us to optimise the distribution of forces under prosthetic restorations functioning as full dental arches.

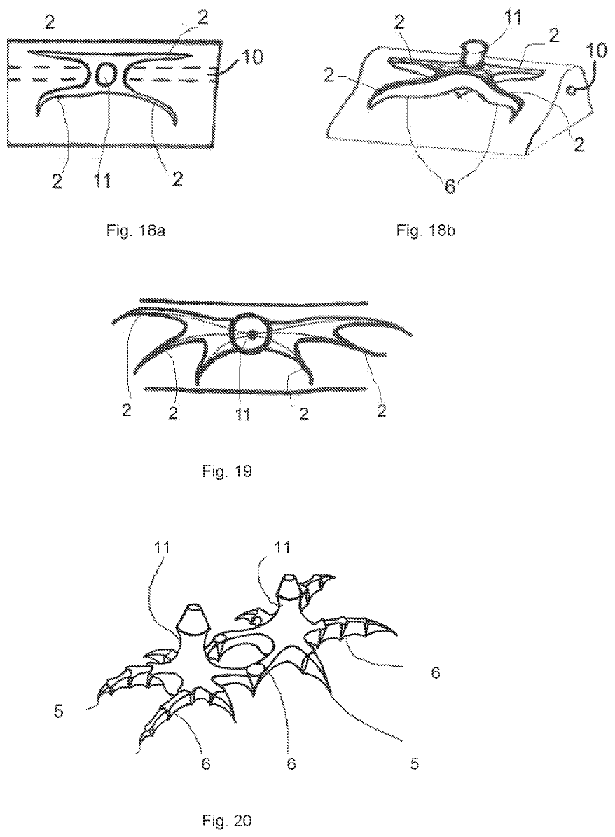

FIG. 18a shows the view from above of a fragment of a mandible with an implant anchor in place, while FIG. 18b presents the same in a perspective view. It can be seen that the core 11 is located directly above the nerve canal 10, without, however, endangering it. The arms 2 of the anchor will run on both sides of the nerve canal 10 penetrating deeper in those places where the volume of bone is greater—just as the roots of a plant grow in soil while bypassing stones.

FIG. 19 presents in diagram form a projection of another sample implant on a plane perpendicular to the axis of the core against the background of the bone. Such an implant is suitable for cases of edentulism, even when there is extreme alveolar atrophy. The implant anchor possesses two arms that in turn branch out into three further arms, where the point on the axis of the core is the place where the axis of the arms begin.

FIG. 20 shows an embodiment where there is one implant with two cores 11.

Unless otherwise specified, relational terms used in these specifications should be construed to include certain tolerances that the skilled in the art would recognize as providing equivalent functionality. By way of example the term perpendicular is not necessarily limited to 90.0°, but also to any slight variation thereof that the skilled in the art would recognize as providing equivalent functionality for the purposes described for the relevant member or element. Terms such as “about” and “substantially” in the context of configuration relate generally to disposition, location, or configuration that is either exact or sufficiently close to the location, disposition, or configuration of the relevant element to preserve operability of the element within the invention which does not materially modifies the invention. Similarly, unless specifically specified or clear from its context, numerical values should be construed to include certain tolerances that the skilled in the art would recognize as having negligible importance as it does not materially change the operability of the invention.

In these specifications reference is often made to the accompanying drawings which form a part of the disclosure, and in which are shown by way of illustration and not of limitation, exemplary implementations and embodiments. Further, it should be noted that while the description provides various exemplary embodiments, as described below and as illustrated in the drawings, this disclosure is not limited to the implementations described and illustrated herein, but can extend to other embodiments as would be known or as would become known to those skilled in the art. Reference in the specification to “one embodiment”, “this embodiment”, “these embodiments”, “several embodiments”, “selected embodiments”, “some embodiments” “aspect”, “aspects”, “certain aspects”, “Some aspects” and the like, means that a particular feature, structure, or characteristic described in connection with the embodiment(s) and/or aspect(s) may be included in one or more implementations, and the appearances of these phrases in various places in the specification are not necessarily all referring to the same embodiment(s). Additionally, in the description, numerous specific details are set forth in order to provide a thorough disclosure, guidance and/or to facilitate understanding of the invention or features thereof. However, it will be apparent to one of ordinary skill in the art that these specific details may not all be needed in each implementation. In certain embodiments, well-known structures, materials, processes and interfaces have not been described in detail, and/or may be illustrated schematically, so as to not unnecessarily obscure the disclosure.

For clarity the directional terms such as ‘up’, ‘down’, ‘left’, ‘right’, and descriptive terms such as ‘upper’ and ‘lower’, ‘above’, ‘below’, ‘sideways’, ‘ inward’, ‘outward’, and the like, are applied according to their ordinary and customary meaning, to describe relative disposition, locations, and orientations of various components. When relating to the drawings, such directional and descriptive terms and words relate to the drawings to which reference is made. Notably, the relative positions are descriptive and relative to the above described orientation such as an upright orientation and modifying the orientation would not change the disclosed relative structure.

It will be appreciated that the invention is not limited to what has been described hereinabove merely by way of example. While there have been described what are at present considered to be the preferred embodiments of this invention, it will be obvious to those skilled in the art that various other embodiments, changes, and modifications may be made therein without departing from the spirit or scope of this invention and that it is, therefore, aimed to cover all such changes and modifications as fall within the true spirit and scope of the invention, for which letters patent is applied.

What is claimed is:

1. An bionic intraosseous implant comprising:
at least one rounded core having a prosthetic platform;
at least one anchor integrated with the core;
the single-component anchor comprising at least two bionic arms being curved and tapering towards its distal end and having at least one bone cutting edge for bone penetration by the arm, said cutting edge extending at least partially along the arms longitudinal curvature, the longitudinal axis of any of the implant anchor arm running from the point on the core axis wherein the shape of each anchor and all its arms depend on the properties of the bone to which the anchor is dedicated.

2. A bionic implant as claimed in claim 1, wherein the implant is a dental implant.

3. A bionic implant as claimed in claim 1, wherein the at least one of those arms with cutting edge further comprises at least one pointed end.

4. A bionic implant as claimed in claim 1, wherein the implant is customized to a specific patient.

5. A bionic implant as claimed in claim 1, wherein for the cases of bone deficit where the bone cannot be prepared too deeply the anchor has at least three accordingly short arms with cutting edges.

6. A bionic implant as claimed in claim 1, wherein the at least two of any arms of the at least one anchor are interfused to form an integrated volume.

7. A bionic implant as claimed in claim 1 wherein at least one arm without cutting edges comprises a pointed end which constitutes a central spike.

8. A bionic implant as claimed in claim 1, wherein at least one of the at least two of any arms are branched to at least two arm branches.

9. A bionic implant as claimed in claim 1, wherein the at least one core having a curved axis.

10. A bionic implant as claimed in claim 1, wherein at least one of any arms having at least one protrusion extending therefrom.

11. A bionic implant as claimed in claim 1, wherein the prosthetic platform of the core comprises a concave dome suitable for filling with curable material.
